(19) United States
(12) Patent Application Publication
(10) Pub. No.: US 2012/0231118 A1
(43) Pub. Date: Sep. 13, 2012

(54) METHOD FOR PREPARING SOYBEAN PASTE

(76) Inventors: Eun Seok Jang, Anyang-si (KR); Jae Hyun Chang, Yongin-si (KR); Sung Hun Lee, Goyang-si (KR); Hye Won Shin, Seoul (KR); Won Dae Chung, Seoul (KR); Kang Pyo Lee, Seoul (KR)

(21) Appl. No.: 13/509,525

(22) PCT Filed: Oct. 18, 2010
(86) PCT No.: PCT/KR2010/007118

§ 371 Date: May 11, 2012

(30) Foreign Application Priority Data
Nov. 13, 2009 (KR) 10-2009-0109498

(51) Int. Cl. A23L 1/20

(52) U.S. Cl. 426/46; 426/634

(57) ABSTRACT

Disclosed is a method for preparing a soybean paste including: flaking or crushing raw soybeans, immersing the resulting flaked or crushed soybeans in water, followed by cooking and cooling, homogeneously mixing the soybeans with koji bacteria and a bean or grain powder, followed by fermenting and drying, and mixing the meju with table salt and distilled water and aging the resulting mixture. In accordance with the method, the soybeans are flaked or crushed to advantageously reduce hydrating and cooking periods of soybeans, form cracks on the soybean surfaces and increase surface areas, and allow beneficial microorganisms to easily use nutrients contained in soybeans, thus increase enzyme production, considerably reduce fermentation period of meju and aging period of soybean paste, obtain manufacturing soybean pastes with superior quality and improve production efficiency.

### TECHNICAL FIELD

The present invention relates to a method for preparing a soybean paste and a soybean paste prepared by the method. More specifically, the present invention relates to a method for preparing a soybean paste comprising flaking or crushing raw soybeans, immersing the resulting flaked or crushed soybeans in water, followed by cooking and cooling, homogeneously mixing the soybeans with koji bacteria and a bean or grain powder, followed by fermenting and drying to prepare meju, and mixing the meju with table salt and distilled water and aging the resulting mixture, and a soybean paste prepared by the method.

### BACKGROUND ART

A soybean paste (also called “doenjang”) is divided into a traditional soybean paste prepared by making a soy source (called “ganjang”), separating the soybean liquid and using the remaining solids, an improved soybean paste in which a suitable brine is added to meju and the soybean liquid is not separated, and a combined soybean paste in which the two types are combined.

The traditional soybean paste is prepared by boiling soybeans, molding the resulting paste into blocks or spares, called “meju”, leaving the meju to ferment, aging the meju for 6 to 12 months while immersing the same in brine, separating a soy source (called “ganjang”) from the meju and aging the remaining solids. The improved soybean paste is soybean paste prepared without separation of ganjang. More specifically, the improved soybean paste is prepared by molding the paste into meju in the form of grains, in the similar manner to the afore-mentioned traditional method, preparing koji from the meju grains using koji bacteria such as Aspergillus oryzae and aging the same without performing any immersing process. The combined soybean paste is prepared by combining the traditional method with the improved method. More specifically, the combined soybean paste is prepared by thickly kneading rough-ground meju with low-concentration brine, fermenting the meju and mixing the resulting product with the meju solids left after separating the soy sauce.

Conventional methods for preparing the improved meju include, as shown in FIGS. 1 and 2, a method comprising preparing koji from the grain-shaped meju using koji bacteria such as Aspergillus oryzae, grinding and aging the same without immersing in brine (See FIG. 1), and a method comprising immersing unground grain-shaped meju in brine, separating a soy sauce, and aging the solids (See FIG. 2).

In the conventional method for preparing a soybean paste, when soybean as a main ingredient of soybean paste is used in its original round form without any treatment or processing, moisture cannot be readily permeated into the soybeans, added water cannot be nearly absorbed into the same, and temperature cycles of the soybeans, protein denaturation and soybean color are non-uniform. In addition, preferred is use of powdery ingredients in order to obtain uniformly puffed forms. However, when powdery ingredients are provided to a heater such as cooker, water absorbance is non-uniform due to superior water absorbance capability, thus causing excessively large and small distribution deviation. In addition, soybean is hard and contains trypsin inhibitors to block absorbance and digestion of proteins, hemagglutinin and the like, thus requiring protein denaturation by application of heat during processing. In addition, immersion in water is required to soften soybeans and reduce heating time. The hydration of soybeans generally depends on factors such as porosity and surface area of epidermal tissues of soybeans, immersion temperature, and salts and concentration of immersion water. The immersion period is long, about 10 hours, thus disadvantageously causing economical disadvantages of being labor intensive and time consuming, and of loss of water-soluble nutrients during immersing.

In an attempt to solve these problems associated with soybean characteristics, Japanese Patent Application Nos. 61-132255 and 61-170295 entitled “method for preparing plant crude oils” disclose a method for preparing plant crude oil from plant seeds, comprising removing waste from seeds, crushing, flaking, heating, drying, sterilization, thermal treatment (indirect heating) to realize cell lysis through thermal stress and collecting oils using mechanical force such as is provided by a screw press or filter press.

In addition, Korean Patent Application No. 10-1990-0015727 entitled “method for preparing soybean oils” discloses a method for preparing soybean oils with flavors and tastes more comparable to sesame oil by grinding soybeans, followed by roasting. Korean Patent Application No. 10-2003-87450 entitled “method for preparing soybean source” discloses use of soybeans pre-treated by a series of processes including crushing, peeling, indirect pre-heating, and grinding using an apparatus such as a roller.

As a result of intense research to solve the afore-mentioned problems of the method for preparing improved soybean paste, the inventors of the present invention discovered a method for preparing a soybean paste with excellent taste and quality by grinding soybeans, which can widen crack and surface areas and thus reduce immersing time, and, at the same time, affect growth of soybean surfaces inoculated with Koji bacteria, increase enzyme production, reduce aging time of the soybean paste, and thus solve economical disadvantages caused by a long period of consumption. Finally, the present invention was completed based on this discovery.

### DISCLOSURE OF INVENTION

Therefore, the present invention has been made in view of the above problems, and it is one object of the present invention to provide a method for preparing a soybean paste by flaking or crushing soybeans, which can form cracks on the soybean surfaces and reduce the surface areas, thus reducing immersing and cooking periods, and can activate growth of koji bacteria and thus reduce aging time.

The object of the present invention is accomplished by flaking or crushing raw soybeans to prepare meju, comparing the resulting meju with meju prepared by a conventional method in terms of moisture content variation given different immersion periods, hardness variations in proportion to cooking time, and protease titer at different koji-preparation periods and thus confirming the facts that the meju prepared from the flaked or crushed soybeans can reduce immersing and cooking times, and enzyme production can be increased by providing growth conditions suitable for koji bacteria and fermentation period of meju and aging period of soybean paste can thus be considerably reduced.

In accordance with one aspect of the present invention, provided is a method for preparing a soybean paste including: flaking or crushing raw soybeans; immersing the resulting flaked or crushed soybeans in water, followed by cooking; mixing the cooked soybeans with koji bacteria and a bean or grain powder, fermenting the mixture and drying the same; and mixing the dried meju with table salt and distilled water and aging the resulting mixture.

### BRIEF DESCRIPTION OF DRAWINGS

The above and other objects, features and other advantages of the present invention will be more clearly understood from the following detailed description taken in conjunction with the accompanying drawings, in which:

FIG. 1 is a flowchart schematically illustrating a conventional process for preparing an improved meju soybean paste;

FIG. 2 is a flowchart schematically illustrating a conventional salting-type process for preparing an improved meju soybean paste; and

FIG. 3 is a flowchart schematically illustrating a process for preparing a soybean paste according to the present invention.

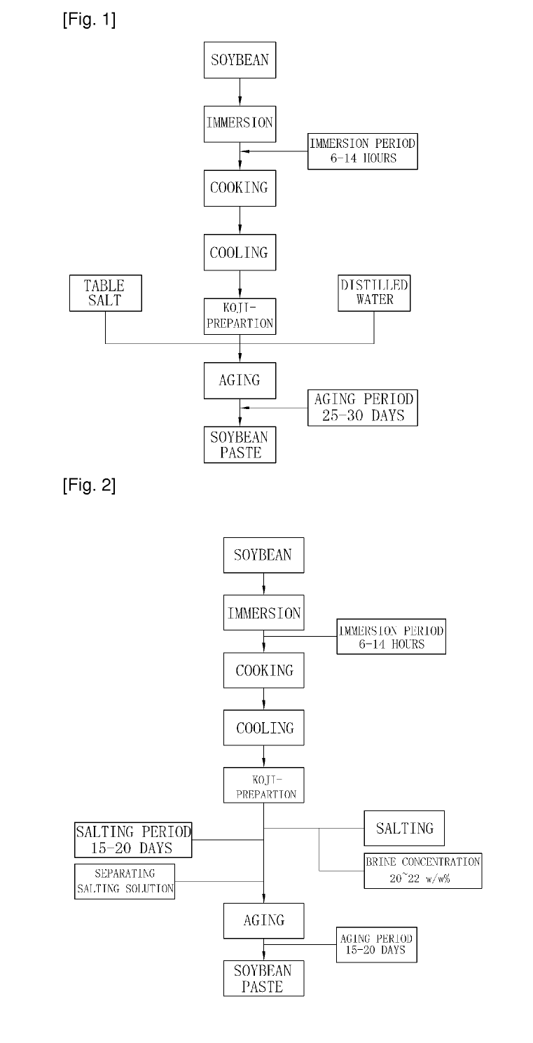

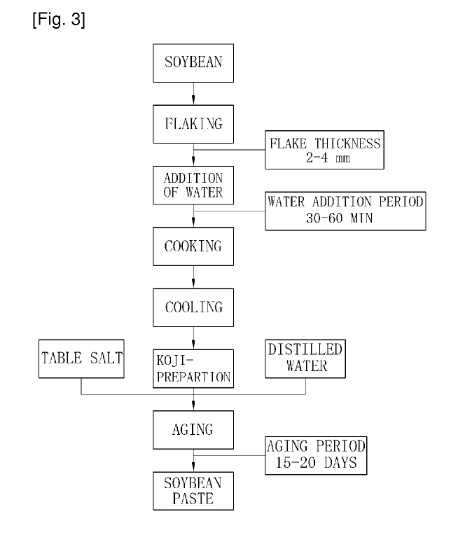

### MODE FOR THE INVENTION

Hereinafter, the present invention will be described with reference to the annexed drawings in more detail.

In one embodiment, the flaking of the raw soybeans may be carried out to a thickness of 2 mm to 4 mm using an apparatus such as a roller. When the soybeans have a thickness of 4 mm or higher, they cannot efficiently absorb water and thus cannot have considerably increased surface areas, thus making it impossible to increase enzyme production to a desired level. On the other hand, when the soybean thickness is less than 2 mm, oils escape from the soybeans, thus negatively affecting growth of microorganisms and flavors.

In addition, the raw soybeans are crushed into two or more fractions, allowing the surface area of the soybeans to increase. Preferably, the soybeans may be crushed into two to ten fractions.

In one embodiment, the flaked or crushed soybeans are immersed in water at ambient temperature (i.e., 25° C.) for 6 to 14 hours to adjust the moisture content of the soybeans to 45 to 60% by weight.

The immersion of the soybeans in water is necessary to soften the soybean tissue and thus reduce heating time. The hydration of the flaked or crushed soybeans according to the method is rapidly completed by immersion for 30 minutes to one hour.

In the present invention, the hydrated soybeans are cooked at 100 to 150° C. at ambient pressure for 20 to 40 minutes and are then cooled to 30 to 40° C.

The soybean cooking is required to denaturate, soften and sterilize proteins, and promote growth of microorganisms during koji-preparation and remove odors of raw soybeans. Generally, the cooking time is varied depending on moisture content of soybeans, cooking temperature, cooking pressure, etc. The cooking is not excessively performed until the soybeans turn dark brown, but is performed until the soybeans turn light yellow or bright brown. The cracks formed on the surfaces of flaked or crushed soybeans according to the present invention allow heat to be efficiently transferred to the inside of the soybeans. For this reason, the cooking can be completed at ambient pressure within 30 minutes.

The cooked soybeans are homogeneously mixed with 0.1 to 0.3% by weight of koji bacteria and 0.5 to 1.5% by weight of a bean or grain powder as an expander, based on the total weight of the ingredients, and the resulting mixture is fermented and dried.

In this process, the cooked soybeans are inoculated with koji bacteria and then incubated, to produce various metabolites by koji bacteria fermentation. The koji bacteria may be selected from fungus including Aspergillus, Rhizopus and Mucor genera, yeasts including Saccharomyces, Hansenula and Torulopsis genera, bacteria of the genus Bacillus and combinations thereof. At this time, the koji bacteria is cooled to a temperature, not inhibiting growth of the cooked soybeans, and is then mixed with an expander (dispersing agent) to reduce initial moisture activity and thus inhibit growth of various germs, and the surfaces of soybeans are inoculated with the resulting mixture. The bean or grain powder used as the expander is a powder of beans or grains generally used in the art. The bean or grain powder is preferably used after being cooked or gelatinized and the kind thereof is not limited. This process is carried out for about 36 to 44 hours. The present invention can accomplish protease production comparable to the conventional improved meju, even when incubating for only 24 to 28 hours.

In the present invention, the dried meju is mixed with table salt and distilled water and is then aged to obtain a desired soybean paste.

The table salt is selected from the group consisting of purified salts, refined salts, natural sea salts, processed salts and combinations thereof.

The flaked or crushed soybeans according to the method can reduce hydration and cooking time, increase surface areas, and allow beneficial microorganisms to easily utilize nutrients contained in the soybeans and thus provide suitable growth conditions, thus increasing enzyme production and considerably reducing fermentation time of meju and aging period of soybean pastes, thereby obtaining soybean pastes with superior quality and improved production efficiency.

### EXAMPLES

Now, the present invention will be described in more detail with reference to the following Examples. These examples are only provided to illustrate the present invention and should not be construed as limiting the scope and spirit of the present invention.

### Example 1

### Preparing Meju Using Flaked Soybeans

Raw soybeans were flaked to a thickness of 2 to 4 mm with a roller and were then immersed in water at ambient temperature (i.e., 25° C.) for 6 to 14 hours to adjust moisture content of the soybeans to 55 to 60% (w/w). The hydrated soybeans were cooked at 120° C. for 30 minutes, were stood to cool to 35° C. and were mixed with 0.3% by weight of koji bacteria and 1.0% by weight of a soybean powder with respect to the weight of soybean, and the surface of flaked soybeans was inoculated with the resulting mixture by spraying. The soybeans were incubated while maintaining the material temperature at 30° C. and relative humidity of 90% for the first 24 hours. Then, koji was prepared from the soybeans, while maintaining the material temperature at 25° C. and the relative humidity of 40% for the overall 36 to 40 hours.

As a result, the maximum moisture absorption period of flaked soybeans was 60 minutes, which corresponds to a 7-fold decrease compared to the 7 hours of the conventional case. The cooking period may vary according to soybean amount and steam pressure, but the reduction thereof can be confirmed from the results shown in Table 2. The optimum size of flaked soybeans was 2 to 4 mm. Under such an optimum flaking condition, protease titer of flaked soybeans increased to 70% or higher, as compared to conventional spherical soybeans.

The hydrating and cooking periods of flaked soybeans are shown in Tables 1 and 2.

The protease of improved meju prepared using flaked soybeans was measured and the results thus obtained are shown in Table 3.

### Example 2

### Preparing Meju by Conventional Method

Soybeans were washed with water, immersed in water at a temperature of 25° C. for 7 hours, cooked at 120° C., stood to cool to 35° C., and inoculated with a mixture of 0.3% by weight of koji bacteria and 1.0% by weight of a soybean powder with respect to the weight of soybeans.

The soybeans were incubated, while maintaining the material temperature at 30° C. and relative humidity of 90% for the first 24 hours. Koji was prepared from the soybeans, while maintaining the material temperature at 25° C. and the relative humidity of 40% for the overall 36 to 40 hours.

The hydrating and cooking periods of spherical soybeans are shown in Tables 1 and 2.

The protease of conventional improved meju is measured and the results thus obtained are shown in Table 3.

TABLE 1
Variations in moisture content of flaked soybeans
at respective immersion periods (unit: wt %)

| Immersion period (min) | Control group | Experimental group |
|---|---|---|
| 0 | 13.0 | 13.0 |
| 15 | 25.3 | 45.4 |
| 30 | 35.8 | 54.7 |
| 60 | 43.1 | 60.5 |
| 120 | 48.3 | 61.2 |
| 180 | 54.2 | 60.4 |
| 420 | 61.6 | 60.8 |
| 840 | 61.8 | 62.3 |

Immersion temperature: 25°
oybean flaking condition: 2-4 mm in thickness
Control group: spherical soybeans (conventional), experimental group: flaked soybeans

TABLE 2
Variations in hardness of flaked soybeans
at respective cooking periods

| | Hardness at respective cooking periods (g) | | |
|---|---|---|---|
| | 60 sec | 120 sec | 180 sec |
| Control group | 1200~1800 | 700~1000 | 400~600 |
| Experimental group | 200~400 | 100~200 | 50~150 |

Hardness: an indicator of cooking degree, which is determined from a pressure in a region in which a cooked soybean is collapsed on a balance when pressed by hand
Control group: spherical soybean (conventional), experimental group: flaked soybean
Cooking period: a period maintained at 120° C. and it takes 60 min to reach 120° C.

TABLE 3
Protease titer of flaked soybeans at respective
koji-preparation periods (unit: IU)

| | |
|---|---|
| Koji-preparation | Experimental group |

| period (hr) | Control group | 2~4 mm | 4 mm or higher |
|---|---|---|---|
| 12 | 14 | 10 | 13 |
| 16 | 56 | 53 | 53 |
| 20 | 118 | 124 | 123 |
| 24 | 146 | 192 | 152 |
| 28 | 172 | 289 | 196 |
| 36 | 207 | 355 | 246 |

Protease is determined in accordancewith Japanese soy sauce test method.
Control group: spherical soybean (conventional), experimental group: flaked soybean

### Example 3

### Preparation of Soybean Paste Using Flaked Soybeans

63.64% by weight of the improved meju (based on 45% by weight of meju moisture) prepared in Example 1 was mixed with 24.36% by weight of distilled water and 12.00% by weight of a table salt and the resulting mixture was aged at ambient temperature for 22 days to prepare a soybean paste. As a result, the soybean paste prepared from flaked soybeans exhibited a ripening level of 501 mg % (based on the aging time of 22 days), which corresponds to a 52% increase over the conventional improved soybean paste, and a 2.2-fold or higher reduction in ripening period over the conventional improved soybean paste (based on the aging time of 22 days).

The ripening level of the improved soybean paste prepared from flaked soybeans was measured and the results thus obtained are shown in Table 4.

### Example 4

### Preparing Soybean Paste by Conventional Method

63.64% by weight of the improved meju (based on 45% by weight of meju moisture) prepared in Example 2 was mixed with 24.36% by weight of distilled water and 12.00% by weight of table salt, and the resulting mixture was aged at ambient temperature for 22 days to prepare a soybean paste.

The ripening level of the conventional improved soybean paste was measured and the results thus obtained are shown in Table 4.

TABLE 4
Variations in ripening level of flaked soybeans
under differentaging periods (unit: mg %)

| | Aging period (day) | | |
|---|---|---|---|
| | 1 | 10 | 22 |
| Control group | 45 | 217 | 329 |
| Experimental group | 97 | 404 | 501 |

Ripening level (amino acid nitrogen): an indicator of ripening level of soybean paste
Control group: improved soybean paste prepared from spherical soybean (conventional), experimental group: improved soybean paste prepared from flaked soybean

### Experimental Example 1

### Functional Tests of Improved Soybean Paste

The functional tests of improved soybean pastes prepared in Examples 3 and 4 were performed by measuring preference of 57 Korean housewives ranging in age from 25 to 49. As a result, the improved soybean paste prepared from flaked soybeans exhibited superior properties, as compared to conventional soybean pastes, as shown in Table 5 below.

TABLE 5
Functional tests of improved soybean
paste prepared from flaked soybeans

| Test items (preference) | Control group | Experimental group |
|---|---|---|
| Overall taste | 2.63 | 3.33 |
| Appearance | 3.18 | 3.35 |
| Flavor | 2.82 | 3.21 |
| Aftertaste | 2.74 | 3.46 |
| Savory | 2.86 | 3.46 |

Appraisal standard: 5-point grades (5: very good, 4: good, 3: average, 2: bad, 1: extremely bad)
Control group: improved soybean paste prepared from spherical soybeans(conventional), experimental group: improved soybean paste preparedfrom flaked soybeans

A case wherein raw soybeans were crushed and the remaining conditions were the same as Example 1 also exhibited similar results to the Experimental Example.

Consequently, crushing of raw soybeans can also reduce hydrating and cooking periods of soybeans, increase soybean surface areas, and allow beneficial microorganisms to easily utilize nutrients contained in the soybeans, and thus increase enzyme production, thus reducing aging period of soybean pastes, preparing soybean pastes with superior quality and improving production efficiency.

As apparent from the afore-going, the present invention provides a method for preparing a soybean paste by flaking or crushing soybeans. As a result, advantageously, it is possible to reduce hydrating and cooking periods of soybeans, form cracks on the soybean surfaces and increase surface areas, and allow beneficial microorganisms to easily use nutrients contained in soybeans, thus increasing enzyme production, considerably reducing fermentation period of meju and aging period of soybean paste and manufacturing soybean pastes with superior quality and improved production efficiency.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for preparing a soybean paste comprising: flaking or crushing raw soybeans; immersing the resulting flaked or crushed soybeans in water, followed by cooking and cooling; homogeneously mixing the soybeans with koji bacteria and a bean or grain powder as an expander, followed by fermenting and drying to prepare meju; and mixing the meju with table salt and distilled water and aging the resulting mixture.

2. The method according to claim 1, wherein the immersion of the flaked or crushed soybeans in water is carried out to adjust the moisture content to 45 to 60% by weight, and the cooking is carried out at 100 to 140° C.

3. The method according to claim 1, wherein the cooked soybeans are mixed with 0.1 to 0.3% by weight of koji bacteria and 0.5 to 1.5% by weight of the bean or grain powder, based on the total weight of the ingredients.

4. The method according to claim 1, wherein the koji bacteria is selected from fungus including Aspergillus, Rhizopus and Mucor genera, yeasts including Saccharomyces, Hansenula and Torulopsis genera, bacteria of the genus Bacillus and combinations thereof.

5. The method according to claim 1, wherein the bean or grain powder mixed with the koji bacteria is cooked or gelatinized.

6. A soybean paste prepared by the method according to claim 1.

7. A soybean paste prepared by the method according to claim 2.

8. A soybean paste prepared by the method according to claim 3.

9. A soybean paste prepared by the method according to claim 4.

10. A soybean paste prepared by the method according to claim 5.
